(19) United States
(12) Patent Application Publication
(10) Pub. No.: US 2007/0233940 A1
(43) Pub. Date: Oct. 4, 2007

(54) Method for updating data in flash memory

(75) Inventor: Shiu-Ming Chu, Taoyuan (TW)

Correspondence Address: BACON & THOMAS, PLLC, 625 SLATERS LANE, FOURTH FLOOR, ALEXANDRIA, VA, 22314, US

(73) Assignee: QUANTA STORAGE INC., Taoyuan (TW)

(21) Appl. No.: 11/727,022

(22) Filed: Mar. 23, 2007

(30) Foreign Application Priority Data
Apr. 3, 2006 (TW) 95112067

(51) Int. Cl. G06F 12/00

(52) U.S. Cl. 711/103

(57) ABSTRACT

A method for updating data in a flash memory previously reserves a rewritable memory area for specific data, searches an address of latest modified data of data to be modified in the flash memory and modifies a backup of latest modified correct data. The method does not update the data when the modified data and the latest modified correct data are the same. When the modified data and the latest modified correct data are not the same, a whole sector where the specific data is located is updated if no unfilled area of the rewritable memory area exists, and the modified data is written into the previously reserved memory area after the address of the latest modified data to complete updating the data if the unfilled area of the rewritable memory area exists.

This application claims the benefit of Taiwan application Serial No. 95112067, filed Apr. 3, 2006, the subject matter of which is incorporated herein by reference.

### BACKGROUND OF THE INVENTION

1. Field of the Invention

The invention relates in general to a method for updating a flash memory, and more particularly to a method of modifying system parameter data stored in a flash memory by way of directly writing.

2. Description of the Related Art

When data stored in a flash memory (e.g., flash ROM) is modified in a conventional electronic device, a sector is regarded as one unit, and the data of the whole sector has to be erased so that to-be-updated data may be written into the whole sector. FIG. 1 (Prior Art) is a flow chart showing a conventional method for updating data in a flash memory. When the data is started to be updated in step 1, the electronic device searches an address of to-be-updated data, and the sector, in which the data needs to be updated, is read for backup in step 2. Next, step 3 of erasing the data is performed to clear all the sector data of the flash memory. Then, step 4 is performed to check whether the data has been completely erased. If the data is not completely erased, step 5 is performed to let the user select whether the process has to be retried. If the process is to be retried, the procedure goes back to step 3. If the process needs not to be retried, the erasing fails in step 6 and step 12 of ending the updating procedure is entered.

When step 4 checks that the data has been completely erased, step 7 is performed to modify the data stored in the backup sector, and the whole data in the modified backup sector is written into the flash memory in step 8 and a check code disposed after the sector data is generated to serve as the basis for checking whether the modified sector data is correct by way of summation (check sum) so that the specific sector of the flash memory is updated. Then, step 9 checks whether the data has been completely written. If the data is not completely written, step 10 is performed to let the user select whether the process has to be retried. If the process has to be retried, the procedure goes back to step 3. If the process does not have to be retried, the writing fails in step 11, and the step 12 of ending the updating procedure is entered. If the modified data is completely written into the specific sector, the object of modifying the sector data can be achieved and step 12 ends the updating procedure.

However, the conventional electronic device modifies the data stored in the flash memory by way of read-erase-modify-write, so the sector data of the flash memory has to be cleared first before the data is rewritten. Even if the single parameter in the sector has to be modified, the sector updating step based on the sector serving as the minimum unit has to be performed. Thus, when the data is updated in the conventional flash memory, a lot of time is wasted in erasing and writing steps. More particularly, the large sector needs the longer time, thereby influencing the efficiency of the electronic device. In addition, when the erasing fails and the writing fails, the data in the erased sector cannot be recovered and the normal operation of the electronic device is thus influenced. Meanwhile, when the backup sector data is being modified, the backup data may be lost if the unpredictable condition, such as power off, occurs. Thus, the information stored in the whole sector may be lost, and the electronic device cannot operate. Thus, the conventional method for updating the sector data of the flash memory in the electronic device still has some problems to be solved.

### SUMMARY OF THE INVENTION

The invention is directed to a method of updating data in a flash memory, which can modify the data in the flash memory without erasing the sector data so as to prevent the sector data from being lost.

The invention is also directed to a method of updating data in a flash memory, which can enhance the updating efficiency by previously reserving a rewritable format to make the modified data be directly written in order.

The invention is also directed to a method of updating data in a flash memory, which can save the updating time by only correcting the sector data without rearranging the whole sector.

According to the present invention, a method for updating data in a flash memory is provided. The method previously reserves a rewritable memory area for specific data, searches an address of latest modified data of data to be modified in the flash memory and modifies a backup of latest modified correct data. The method does not update the data when the modified data and the latest modified correct data are the same. When the modified data and the latest modified correct data are not the same, a whole sector where the specific data is located is updated if no unfilled area of the rewritable memory area exists, and the modified data is written into the previously reserved memory area after the address of the latest modified data to complete updating the data if the unfilled area of the rewritable memory area exists.

Then, the updating step ends if it is checked that the modified data has been completely written into the memory area, and the user may select to retry and execute the updating step if the data cannot be completely written, or the incorrect data is reserved in the memory area and the updating procedure ends if the data is not completely written and the user selects not to retry. The invention can previously reserve a plurality of rewritten areas after the address of the specific data. Thus, when the data is modified, the data can be directly written after the original data without erasing so that the data in the flash memory can be updated.

The invention will become apparent from the following detailed description of the preferred but non-limiting embodiments. The following description is made with reference to the accompanying drawings.

### BRIEF DESCRIPTION OF THE DRAWINGS

FIG. 1 (Prior Art) is a flow chart showing a conventional method for updating data in a flash memory.

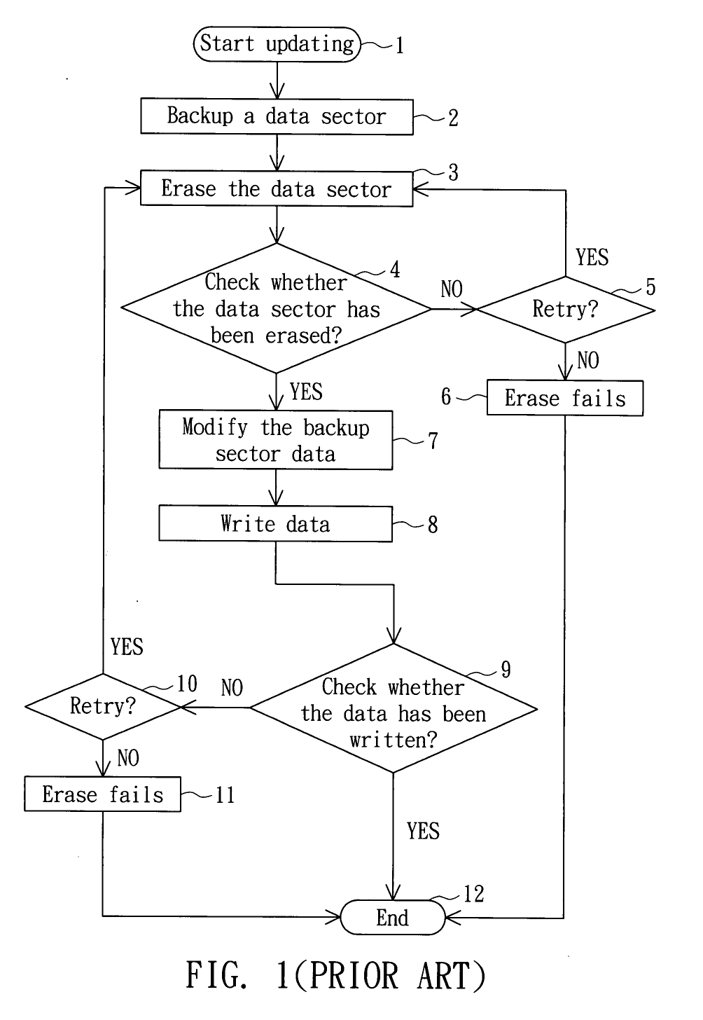

FIGS. 2(a) to 2(d) are schematic illustrations showing procedures in a method for updating data in a flash memory according to the invention.

FIG. 3 is a flow chart showing a method of updating data in a flash memory according to a first embodiment of the invention.

FIG. 4 is a flow chart showing a method of updating data in a flash memory according to a second embodiment of the invention.

### DETAILED DESCRIPTION OF THE INVENTION

The method for updating data in a flash memory according to the invention is utilized to update system parameters stored in the flash memory of an electronic device according to the property, in which the data bit of the flash memory may be modified from 1 to 0, and the data cannot be modified from 0 to 1 until the data of the flash memory is erased. That is, if the data in the flash memory is 0xFF (i.e., [11111111] in the 8-bit system), the data can be arbitrarily and correctly written into the 0xFF data bit of the flash memory without performing erasing procedures.

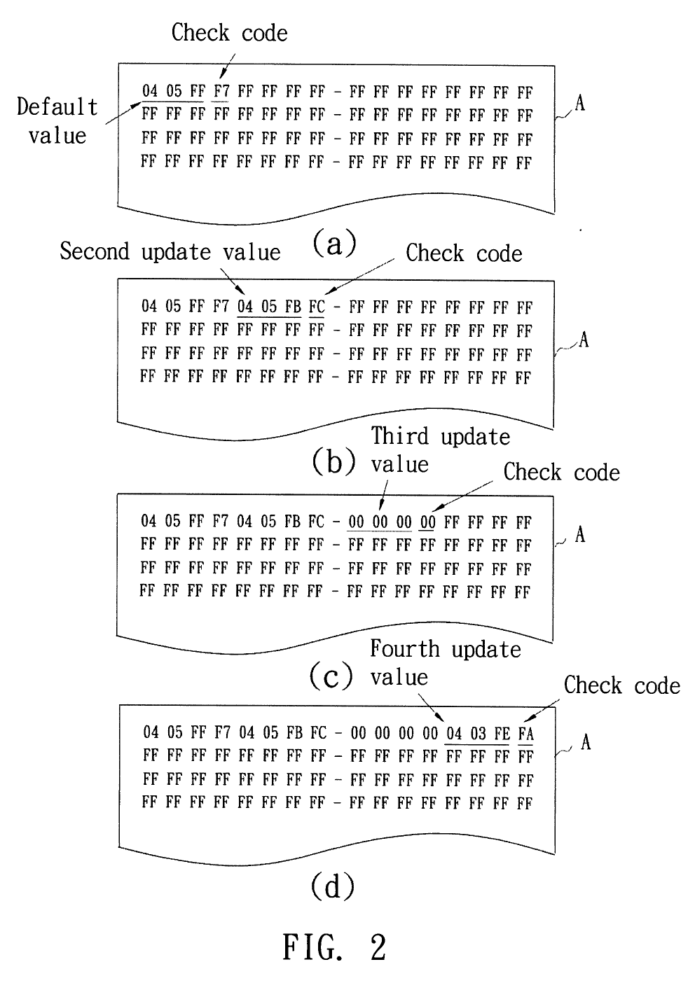

FIGS. 2(a) to 2(d) are schematic illustrations showing procedures in a method for updating data in a flash memory according to the invention. The method for updating the data in the flash memory according to the invention aims at to-be-modified specific data in the electronic device and previously reserves a memory area A being used for the modification of the specific data in the flash memory. FIG. 2(a) shows the data contents of the memory area A in an initial state. The initial data of the memory area A includes a first set of data having the initial value such as an outgoing value [04 05 FF] and a check code [F7], and other contents which are the data of 0xFF.

As shown in FIG. 2(b), if the parameter data needs to be modified, the address of the latest modified data of the parameter is searched first, the address of the latest modified data in the memory area A is ensured, and the backup parameter data is modified. For example, a second set of updated value [04 05 FB] is modified, a summated check code [FC] is generated, and the modified data is again compared with the latest modified data of the parameter. If the two sets of data are the same, the data is not updated, or otherwise the latest written position of the memory area A is found. That is, the check code [F7] of the latest modified parameter data is found. Then, the backup parameter data to be modified is written directly after the check code to serve as the second set of parameter updated data. When the electronic device is operating, the device searches the latest modified parameter data, and checks whether the parameter data is correct according to the check code. If the parameter data checked is correct, it serves as the operating value.

As shown in FIG. 2(c), when the parameter needs to be modified again, the modified backup parameter data, such as the third set of update value [00 00 00] and the check code [00], is written after the second set of update value and the check code [FC] to serve as the third set of parameter updated data in a manner similar to that of FIG. 2(b). If abnormal conditions occur to cause the writing failure when the third set of updated value parameter data is written. When the electronic device is operating, it searches the latest updated third set of parameter data, and checks whether the third set of parameter data is correct according to the check code. Once an error is found, a previous parameter data updated value serves as the operating value. So that the electronic device still can operate to wait for the next time of updating operation without being influenced by the parameter data loss generated by the abnormal conditions such as the writing failure.

As shown in FIG. 2(d), when the incorrect parameter data has to be modified, the modified backup parameter data, such as the fourth set of update value [04 03 FE] and the check code [FA], is written after the third set of update value and the check code [00] to serve as the fourth set of parameter updated data in a manner similar to that of FIG. 2(b). Thus, the incorrect parameter data caused by the previous writing failure can be corrected.

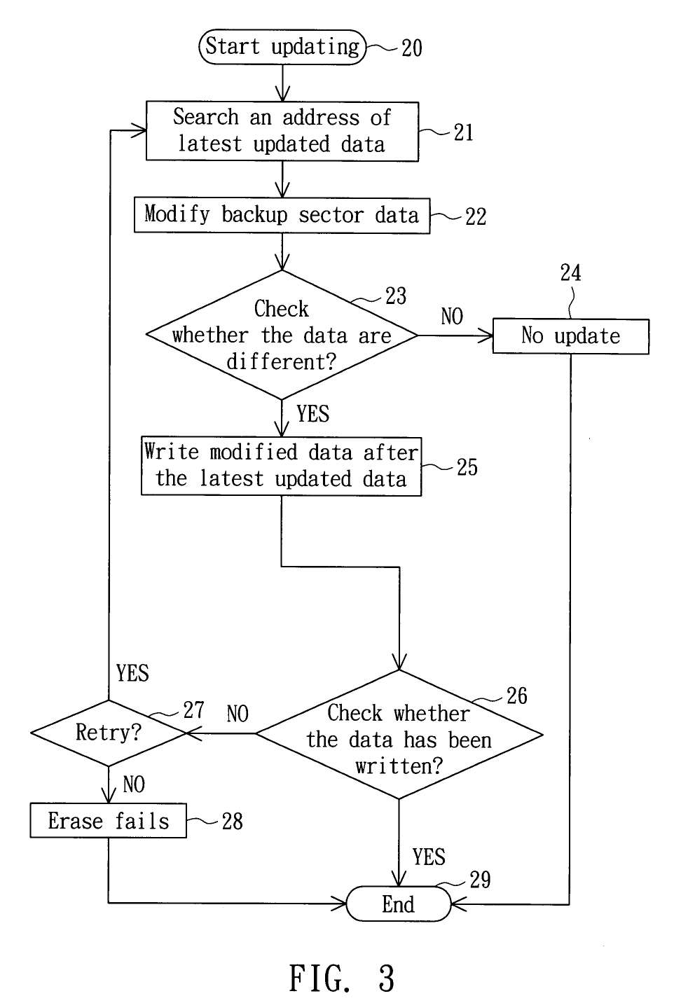

Thus, the invention can update the parameters in the flash memory without erasing the sector data according to the previously reserved rewritable format. FIG. 3 is a flow chart showing a method of updating data in a flash memory according to a first embodiment of the invention. The method for updating the data in the flash memory of the invention will be described in detail in the following. The method includes the following steps.

In step 20, the method starts to update the parameter data stored in the flash memory.

In step 21, the method searches the memory area wherein the parameter data is located in the flash memory, and finds the storage address of the latest modified parameter data according to several sets of parameter data, which are previously corrected and stored.

In step 22, the method reads the latest modified correct parameter data for backup, and modifies the backup parameter data according to the requirement to form the updated parameter data including the update parameter values and the check code generated by summating the update parameter values.

In step 23, the method checks whether the updated parameter data and the latest modified parameter data are different from each other. The procedure goes to step 24 if they are the same, and the procedure goes to step 25 if they are different from each other.

In step 24, the parameter data is not updated. Because the two sets of data are the same, only the originally latest modified parameter data serves as the operating value of the electronic device, and the procedure enters step 29 to end the operation of modifying the parameter data.

In step 25, the method directly writes the modified backup parameter data into the memory area A of the previously reserved rewritable 0xFF format after the address of the check code according to the found storage address of the latest modified parameter data, so as to replace the previous set of parameter data to form the latest modified parameter data and thus to update the parameter data.

In step 26, the method checks whether the modified backup parameter data is completely written into the memory area A so as to ensure the parameter data being correctly updated. When the electronic device has the abnormal condition so that the parameter data cannot be correctly updated, the procedure enters the next step 27 for requesting the retrying. If the parameter data is correctly updated, the procedure enters step 29 to end the updating procedure.

In step 27, the user may select whether the process has to be retried. If the process has to be retried, the procedure goes back to step 21 for repeatedly performing the updating step from the found storage address of the latest modified parameter data. If the procedure needs not to be retried, the procedure enters the next step 28.

In step 28, when the parameter data is not completely written and the user selects not to retry, the incorrect parameter data will be left at the address of the updated parameter data. Thus, the writing fails and the correctly updated parameter data cannot be obtained, and the procedure enters the next step 29.

In step 29, the operation of updating the parameter data ends.

Thus, according to the steps of updating the parameter data, the method for updating the data in the flash memory according to the first embodiment of the invention aims at the data, such as the region code of the DVD optical drive, which is often needed to be corrected. The same batch of outgoing products of the DVD optical drives may be sold to different countries. Thus, the outgoing predefined value of the region code stored in the flash memory has to be modified. Thus, it is possible to previously reserve a plurality of rewritable areas after the address of the specific data according to the plan in advance. Thus, the modified data can be direct written after the original data without performing the read-erase-modify-write steps on the whole sector so that the data of the flash memory may be updated. Thus, it is possible to prevent the whole sector data from being lost, and only a specific portion of the data in the sector has to be corrected and stored without re-arranging the whole sector. Thus, the updating time can be shortened, and the updating efficiency can be enhanced.

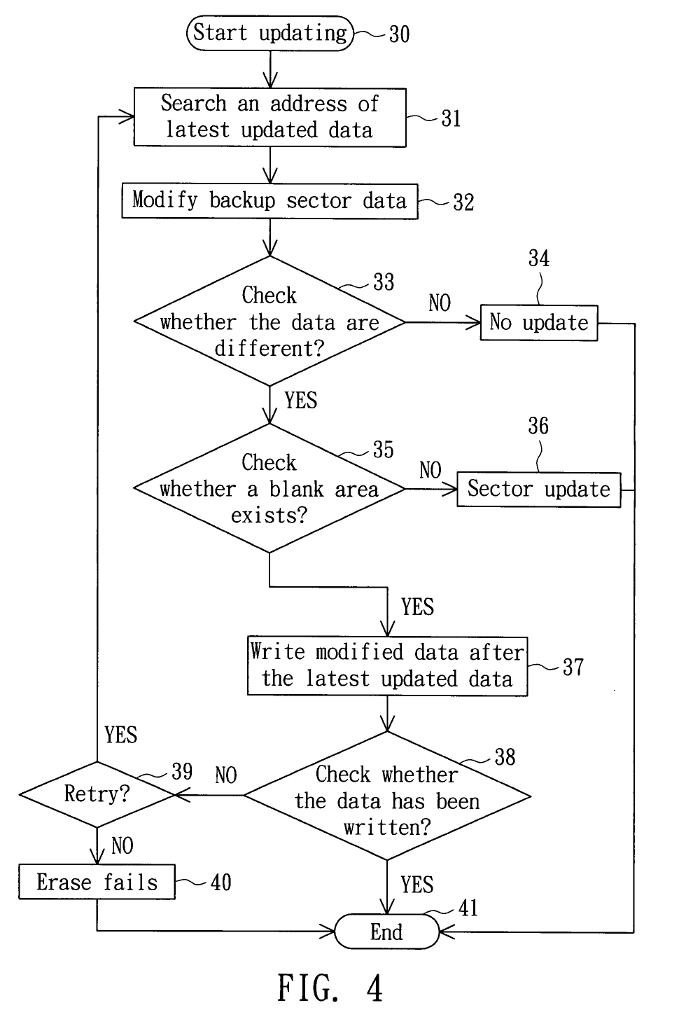

FIG. 4 is a flow chart showing a method of updating data in a flash memory according to a second embodiment of the invention. As shown in FIG. 4, as for the to-be-corrected data, a plurality of rewritable areas is previously reserved in the flash memory and step 30 of starting updating is performed. Then, step 31 of searching the latest updated data is performed, step 32 of modifying the backup sector data is performed, step 33 of checking whether the two sets of data are different from each other is performed, step 34 of not updating the data is performed, step 37 of writing the data after the address of the latest updated data is performed, step 38 of checking whether the data has been written is performed and step 39 of retrying is performed. Then, in step 40, the writing fails, and the updating procedure ends in step 41. These steps and functions are the same as those of the first embodiment of the invention.

The second embodiment of the invention mainly differs from the first embodiment in step 33 of checking whether the two sets of data are different from each other. If the updated parameter data and the latest modified parameter data are different from each other, step 35 of checking whether the unfilled area of is added before step 37 of writing the data after the address of the latest updated data in order to check whether the previously reserved rewritable memory area A is filled with the multiple times of updated parameter data. If the area A is not filled with the updated parameter data, it means that the data still can be directly written and updated, and the procedure enters step 37 of writing the data after the address of the latest updated data, step 38 of checking whether the data has been written, step 39 of retrying, step 40 of failing to write, step 41 of ending the updating procedure, and the steps of the first embodiment of the invention to finish the updating procedure. When the memory area A is filled with the parameter data, the procedure enters step 36 of sector updating, which corresponds to the conventional read-erase-modify-write steps. When the data is again written, the sector is formatted again, only the latest updated correct parameter data is reserved, and the other parameter data is deleted. Then, the rewritable memory area A is reserved again in advance. After the updating procedure, step 41 of ending the updating is entered.

Thus, according to the step of updating the parameter data, the method for updating the data in the flash memory according to the second embodiment of the invention can previously reserve a plurality of rewritable areas in the flash memory, as done in the first embodiment without erasing and updating the data in the whole sector. Thus, the electronic device can rapidly update the data of the flash memory, and can update the parameters for an unlimited number of times through the recovering procedure.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for updating data in a flash memory, comprising the steps of:
(1) searching an address of latest modified data of to-be-modified data in the flash memory;
(2) modifying a backup of latest modified correct data;
(3) checking whether the modified data of a backup and the latest modified correct data are different, wherein the data is not updated if the modified data of a backup and the latest modified correct data are the same, and step (4) is performed when the modified data of a backup and the latest modified correct data are different from each other; and
(4) writing the modified data of a backup into a previously reserved memory area after the address of the latest modified correct data.

2. The method according to claim 1, wherein the step (1) finds the address of the latest modified data from plural sets of data.

3. The method according to claim 1, wherein the step (2) generates updated parameter data by updating data values and a summated check code.

4. The method according to claim 3, wherein the step (2) checks whether the data is correct according to the check code, modifies the latest modified data if the data is correct, and takes previous data as an operating value when the data is incorrect.

5. The method according to claim 1, wherein the original latest modified data is reserved as an operating value when the step (3) does not update the data.

6. The method according to claim 1, wherein an initial state of the previously reserved memory area in the step (4) is a format rewritable state.

7. The method according to claim 6, wherein a rewritable format of the memory area is a 0xFF format.

8. The method according to claim 6, wherein first data includes an outgoing value and a check code in the initial state of the memory area.

9. The method according to claim 1, further comprising, after the step (4), the steps of:
(5) checking whether the modified data has been completely written into the memory area, and ending an updating procedure if the modified data has been completely written into the memory area or otherwise performing step (6);
(6) selecting whether to retry, and going back to the step (1) to execute the step of updating the data repeatedly when selecting to retry or otherwise ending the updating procedure.

10. The method according to claim 9, wherein when the data is not completely written and it is selected not to retry in the step (6), the incorrect data is reserved in the memory area, and then the updating procedure ends.

11. The method according to claim 1, wherein steps (3) comprises, when two sets of data are different from each other, the step of:
(3-1) checking whether the unfilled area of the previously reserved memory area of the data exists, and performing step (4) if the previously reserved memory area exists or otherwise updating a whole sector where the data is located.

12. The method according to claim 11, wherein the step (3-1) updates the whole sector by way of read-erase-modify-write.

13. The method according to claim 11, wherein when the step (3-1) is updating the whole sector, the latest modified correct data is written and reserved, other parameter data are deleted, and a rewritable memory area is again reserved.

14. The method according to claim 1, wherein the data is a system parameter of an electronic device stored in the flash memory.

15. The method according to claim 14, wherein the system parameter is a region code of an optical drive.
